(19) United States
(12) Patent Application Publication
(10) Pub. No.: US 2018/0071581 A1
(43) Pub. Date: Mar. 15, 2018

(54) METHOD FOR LINKING PEOPLE WITH SIMILAR INTEREST IN AN ATHLETIC ACTIVITY AND RELATED INTERACTIVE SOCIAL NETWORKING PLATFORM

(71) Applicant: Po-Chun CHANG, Kaohsiung City (TW)

(72) Inventor: Po-Chun CHANG, Kaohsiung City (TW)

(21) Appl. No.: 15/265,056

(22) Filed: Sep. 14, 2016

(51) Int. Cl. A63B 24/00; G06F 17/30; G06Q 30/02

(52) U.S. Cl. CPC A63B 24/0062; G06F 17/30241; H04L 67/306; G06Q 30/0241; G06F 17/30831

(57) ABSTRACT

An interactive social networking platform which can be used by a plurality of users comprises an interactive servo unit, and a database unit. The interactive servo unit includes an athletic activity linking module to offer the users to create at least one athletic activity in the interactive servo unit. The database unit is electrically connected to the interactive servo unit, and includes a user database and an activity database. A plurality of users can access to the interactive servo unit and choose whether to join in the athletic activity. The user's profile can be saved in the athletic activity by the athletic activity linking module, so that a plurality of users with similar interest in an athletic activity can be linked together.

### BACKGROUND OF THE INVENTION

### a) Field of the Invention

The present invention relates to a matching method, and more particularly to a method for linking people with similar interest in an athletic activity and an interactive social networking platform thereof.

### b) Description of the Prior Art

Nowadays, most people prefer to do exercise to maintain health and fitness in their holidays. However, most outdoor exercises have venue limitations and a minimum player or competitor number, so at earlier times, exercise companions comes from acquaintances, and because everyone has each other's contact information, an exercise activity can be appointed.

However, when the number of exercise companions cannot satisfy a minimum player number of an athletic activity (for example, the total baseball player number of two teams are at least 18 players), the athletic activity will be cancelled to waste precious recreation time.

Please refer to the Taiwan Patent No. 201510907, entitled “the real-time information exchange system and method for online athletic team”, in which a plurality of athletic teams can participate in the competitive activities via internet. The prior art can make the athletic activity more fun by creating competition among different teams, so that people are more willing to join in. However, team organizing is a first threshold, if the number of player is not enough to organize a team, the competitive activity cannot be started.

Although there are few athletic activities using social networking websites to invite people to do exercise at an appointed place (for example, jogging), they are only suited for some large venues which can contain a bunch of people, but not suited for most athletic activities.

From the above descriptions, certain problems still exist with current social networking website for promoting athletic activities:

1. Team Organizing is Necessary

In regard to the athletic activities required for competitors or companions, good interpersonal relation is necessary for inviting participants, and one-by-one contact is also necessary for confirming each one's attendance to decide an appointed venues. On the other hand, when applying for a team competitive activity, a team cannot be created due to lack of enough participants.

2. Not Suited for Most Athletic Activities

The social networking websites for inviting people to join in athletic activities need to have a venue for contain their participants. When an athletic activity is created, exercise can be started, but most athletic activities have participant number limitation, are not suited for a bunch of people to join in.

Therefore, how to link enough people with similar interest in an athletic activity effectively at an appointed place is a primary problem to solve.

### SUMMARY OF THE INVENTION

Therefore, an objective of an embodiment of the present invention is to provide an interactive social networking website which can be used by a plurality of users and comprises an interactive servo unit and a database unit.

The interactive servo unit includes a user module, an athletic activity linking module and a communication module for contacting a plurality of users. The user module is programmed to control the users' access right on the interactive servo unit, and the athletic activity linking module is programmed to offer at least one user to create at least one athletic activity on the interactive servo unit. The database unit is electrically connected to the interactive servo unit, including a user database programmed for saving information from a plurality of users, and an activity database programmed for saving the created athletic activities. A plurality of users can access to the interactive servo unit, choosing whether to join in the athletic activity, and their information can be saved in the athletic activity by the athletic activity linking module. Therefore, the communication module controlled by the activity database will notify the participants in the athletic activity, so that people with similar interest in an athletic activity can be linked together.

Another technique of an embodiment of the present invention is that the database unit further includes a map database programmed for planning a route. The users' coordinates can be saved in the user database, and the venue coordinates of the athletic activity can be saved in the activity database. The user's coordinate and the venue coordinates are combined with the map database to plan a route for a plurality of users by the athletic activity linking module.

Another technique of an embodiment of the present invention is that the interactive servo unit further includes a team organizing module and a team linking module. The team organizing module offers at least one user to create at least one athletic team, and allow people with similar interest in an athletic activity to join in. When a plurality of teams is created on the interactive social networking platform, the team linking module offers at least one user to create a team competitive activity and offers a plurality of team to sign up. The database unit further includes a team database programmed to save the information of the athletic teams, and a competitive activity database programmed for saving the information of the team competitive activities.

Another technique of an embodiment of the present invention is that the interactive servo unit further includes an advertisement sponsoring module by which a plurality of outside suppliers can sponsor the athletic activity, the athletic team, the team competitive activity or combination thereof. The database unit further includes a commercial sponsoring database programmed to save information of outside suppliers.

Another technique of an embodiment of the present invention is that the interactive servo unit further includes a competition scoring module, which is provided with an individual ranking calculated from users' scores, and a team ranking calculated from teams' scores. The database unit further includes a ranking database to save the individual rankings and team rankings.

Another technique of an embodiment of the present invention is that the interactive servo unit further includes a video broadcasting module, which is provided with a plurality of videos offered by at least one user. The database unit further includes a video database for saving the videos, and the users can watch the uploaded video simultaneously on the interactive platform, and also can watch the video saved in the video database.

Moreover, another objective of an embodiment of the present invention is to provide a method for linking people with similar interest in an athletic activity, which is applied to the interactive social networking website described by any one of 1˜5 claims, comprising an athletic activity creating step, a recruiting step, a signing up step, and a linking noticing step.

In the athletic activity creating step, the athletic activity linking module offers at least one user to create an athletic activity, in which a required participant number is provided. In the recruiting step, the athletic activity is published by the interactive social networking platform, so that users login to the interactive social networking platform and access to the athletic activity related information. In the signing up step, the users' registration is accepted by the athletic activity linking module, and the information of registered users is saved in the athletic activity. In the linking noticing step, when the participant number can satisfy the requirement, the recruitment will be closed by the athletic activity linking module, and the communication module will notify the participants.

Another technique of an embodiment of the present invention is that the method for linking people with similar interest in an athletic activity further comprises a map arranging step occurred between the recruiting step and signing up step. The athletic activity is further provided with a venue coordinate of the athletic activity, and when a plurality of athletic activity information is saved by the activity database, the athletic activity linking module will plan routes for a plurality of users according to the distance between the venue coordinate and the user coordinate.

Another technique of an embodiment of the present invention is that the method for linking people with similar interest in an athletic activity further comprises a team competition step. When people with similar interest in an athletic activity are linked to organize a team by the team organizing module, the team linking module can offer at least one user to create one team competitive activity and offer the athletic teams to participate, so that a plurality of athletic teams can be linked together.

Another technique of an embodiment of the present invention is that the method for linking people with similar interest in an athletic activity further comprises a sponsoring step. The advertisement sponsoring module can offer the outside suppliers to sponsor at least one user, one team, a team competitive activity or combination thereof.

An advantage of embodiments of the invention is that, an interactive social networking pursuit of exercise can be built on the internet, where a plurality of users can login and create their profiles. The interactive social networking website can offer users to create different types of athletic activity, which can be published to other users. When a user is interested in one of the athletic activity, the user can sign up the athletic activity on the interactive social networking platform. When the required participant number is satisfied, the athletic activity linking module can control the communication module to notify the users, so that the users can receive athletic activity information. Therefore, people with similar interest in an athletic activity can be successfully linked together.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 is a flow chart depicting a first preferred embodiment according to the present invention;

FIG. 2 is a flow chart depicting an athletic activity of the first preferred embodiment according to the present invention;

FIG. 3 is a flow chart depicting a user's coordinate of the first preferred embodiment according to the present invention;

FIG. 4 is a flow chart assistant to depicting of the first preferred embodiment according to the present invention;

FIG. 5 is a flow chart depicting a second preferred embodiment according to the present invention; and

FIG. 6 is a flow chart depicting a third preferred embodiment according to the present invention.

### DETAILED DESCRIPTION OF THE PREFERRED EMBODIMENTS

Specific structural and functional details disclosed herein will become apparent from the following descriptions of the three preferred embodiments of the present invention taken in conjunction with the accompanying drawings.

Before explaining the present invention in detail, it is to be understood that similar elements are labeled with the same reference numbers.

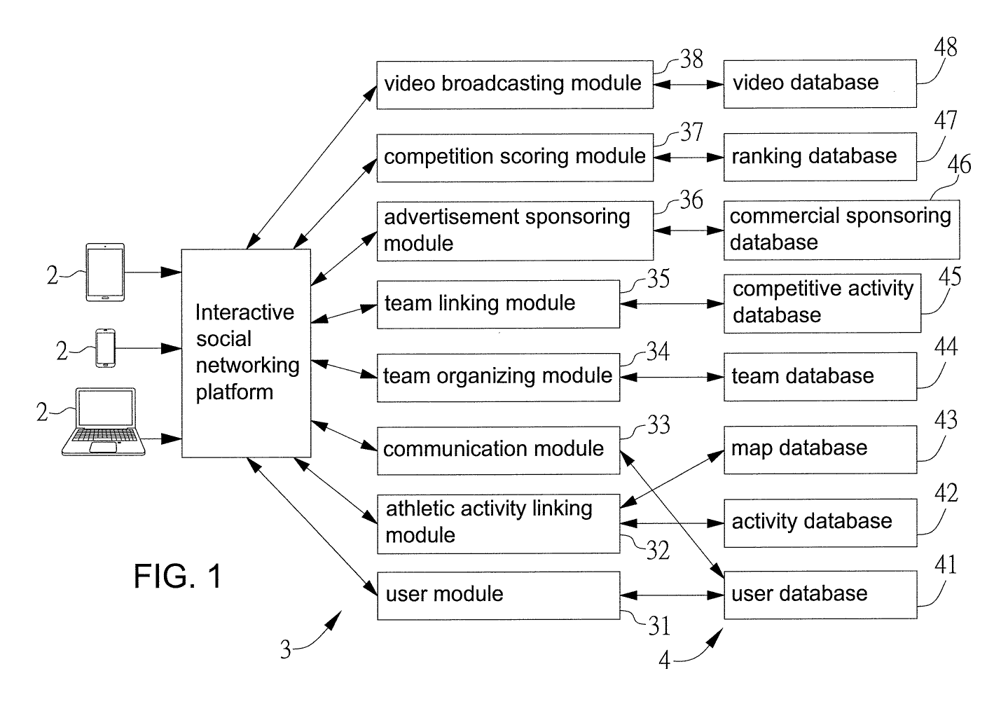

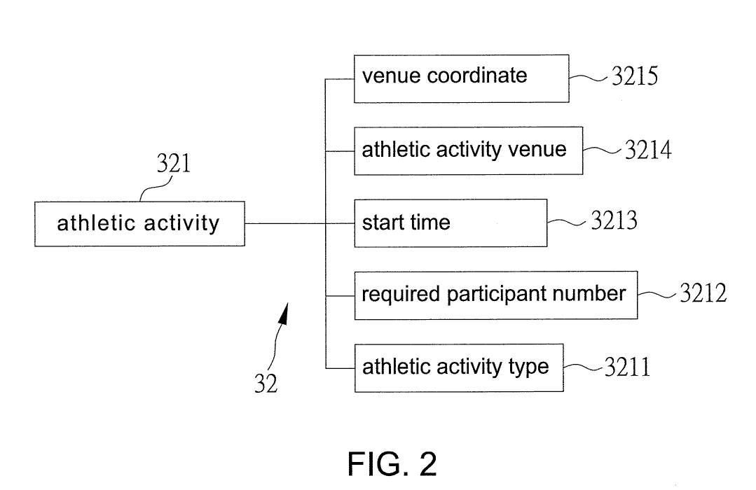

With reference to FIGS. 1 and 2, a first embodiment of the present invention is provided, which can be used by a plurality of users 2, comprising an interactive servo unit 3 and a database unit 4.

The interactive servo unit 3 includes a user module 31, an athletic activity linking module 32 and a communication module 33 for contacting a plurality of users 2. The user module 31 is programmed to control the users' 2 access right on the interactive servo unit 3, and the athletic activity linking module 32 is programmed to offer at least one user 2 to create at least one athletic activity 321 on the interactive servo unit 3.

The database unit 4 is electrically connected to the interactive servo unit 3, including a user database 41 programmed for saving information from a plurality of users 2, and an activity database 42 programmed for saving the created athletic activities 321. An athletic activity type 3211, a required participant number 3212, a start time 3213 and an athletic activity venue 3214 are saved in the athletic activities 321.

A plurality of users 2 can access to the interactive servo unit 3 and browse information of the athletic activity 321, by which they can choose adequate athletic activities 321. When the users 2 are interested in the athletic activities 321 and sign up, the information of the users 2 are saved in the athletic activity 321 by the athletic activity linking module 32. The communication module 33 controlled by the activity database 42 will send the users 2 participating in the athletic activity 321 a message of “the athletic activity 321 has been successfully established, and pleases show up on appointed time”. Therefore, linking users 2 with similar interest in an athletic activity together can be obtained by the invention.

For example, a user 2 want to play badminton at a desired time, and all the acquaintances of the user 2 are not available to participate, so that the user 2 cannot play badminton. At this time, the user 2 can login to the present invention interactive social networking platform to search for an athletic activity 321 of badminton created by other users 2, and choose adequate athletic activity 321 to sign up. When registration is completed, the athletic activity linking module 32 will control the communication module 33 to send the registered users 2 and the athletic activity 321-created users 2 the message of “the athletic activity 321 is successfully established and please show up on appointed time at athletic activity venue 3214, so that users 2 who are mutually unacquainted and both want to play badminton can be linked together by the present invention.

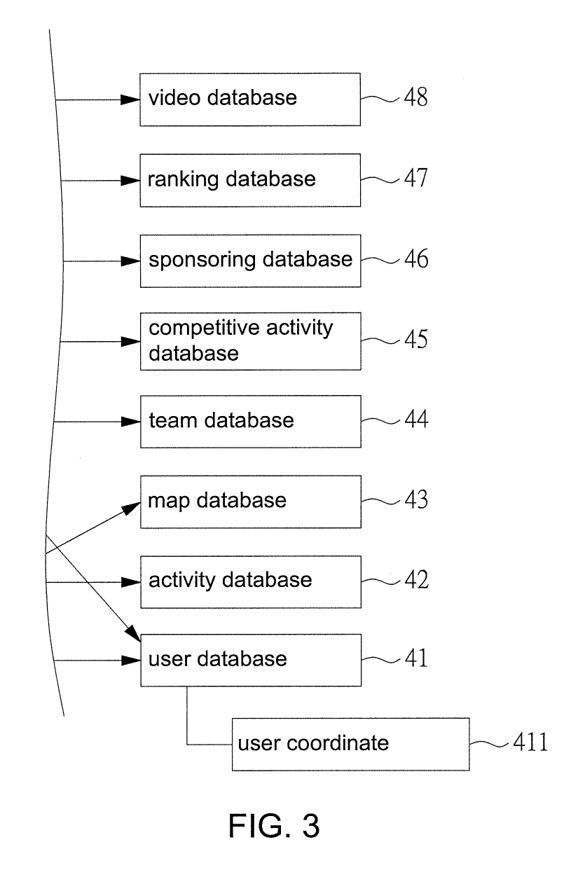

With reference to FIG. 3, the database unit 4 further includes a map database 43 programmed for planning routes. The users' 2 coordinates 411 are saved by the user database 41, and the venue coordinate 3215 of the athletic activity 321 is saved by the activity database 42. The user's coordinates 411 and the venue coordinates 3215 are combined with the map database 43 to provide a plurality of users 2 routes by the athletic activity linking module 32.

It is worth mentioning that when a plurality of athletic activity 321 created on the interactive servo unit 3 is provided to a plurality of users 2, the athletic activity linking module 32 can calculate the distance and arrange the best route between the venue coordinates 3215 and the user coordinates 411 to provide the users 2 a plurality of athletic activity 321 listed from nearest to farthest distance. A plurality of users 2 can choose a desired athletic activity 321 based upon the route distance.

Preferably, the map database 43 can link to other websites' map resource to avoid consuming too many memories and to avoid wasting too many resources to slow down the interactive servo unit 3. In practice, it should not be construed as limiting the invention.

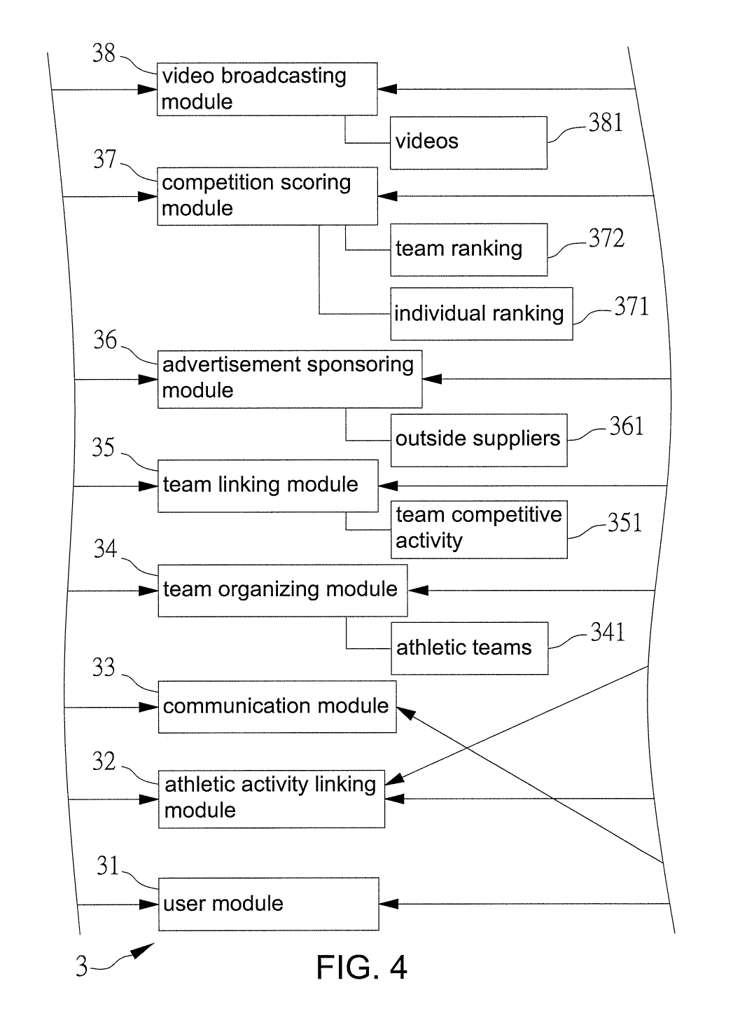

With reference to FIG. 4, the interactive servo unit 3 further includes a team organizing module 34 and a team linking module 35. The team organizing module 34 offers at least one user 2 to create at least one athletic team 341, and allows users 2 with similar interest in an athletic activity to join in. When the a plurality of athletic teams 341 is created on the interactive social networking platform, the team linking module 35 offers at least one user 2 to create a team competitive activity 351 and offers a plurality of athletic teams 341 to sign up. The database unit 4 further includes a team database 44 programmed to save the information of the athletic teams 341, and a competitive activity database 45 programmed for saving the information of the team competitive activities 351.

The team organizing module 34 provides the users 2 a recruiting service for creating team competitions and it can create different athletic teams 341 based upon different types of athletic activities. Each type of athletic activity can create a plurality of athletic teams 341 based upon venue, time and participant number. The team organizing module 34 can provide the users 2 a plurality of athletic teams 341 and the users 2 can choose an adequate athletic team 341 to sign up, and then become teammates of the athletic activity 341. The team organizing module 34 can indeed link the users 2 who are mutually unacquainted and with similar interest in an athletic activity together, and organize a team to join in a team competition.

The team linking module 35 is provided for the athletic teams 341 to create a team competitive activity 351, and allows other athletic teams 341 to sign up. The team competitive activity 351 can be a regional competition held in an athletic venue, or also can be a large-scale athletic competition held in several venues. The competition information has to be filled in fully when creating the team competitive activity 351, so that a plurality of athletic teams 341 can browse and choose an adequate competitive activity to join in.

When the registration of the team competitive activity 351 is completed, the team linking module 35 will control the communication module 33 to notify the users 2 of the related competition information saved in the competitive activity database 45. The information includes that the team competitive activity 351 has satisfied competition condition and will be held on scheduled time, and the athletic team 341 should show up on time. Therefore, linking a plurality of athletic teams 341 with similar interest in an athletic activity together can be obtained by the team organizing module 34.

With respect to the first preferred embodiment, it is noted that the interactive servo unit 3 further includes an advertisement sponsoring module 36 by which a plurality of outside suppliers 361 can sponsor one of the athletic activity 321. The database unit 4 further includes a commercial sponsoring database 46 programmed to save information of outside suppliers 361. A plurality of outside suppliers can be individuals or companies. When the interactive servo unit 3 publishes at least one athletic activity 321, the advertisement sponsoring module 36 can provide a plurality of outside suppliers 361 for browsing and sponsoring the athletic activity 321.

Besides, the advertisement sponsoring module 36 can also provide a plurality of outside suppliers 361 for sponsoring the user 2, the athletic activity 321, the athletic team 341 or the team competitive activity 351, and can choose to sponsor with commercial advertisement or merely sponsor for promoting athletic activity.

The interactive servo unit 3 further includes a competition scoring module 37 and a video broadcasting module 38. The competition scoring module 37 which is provided with an individual ranking 371 calculated from users' 2 scores of the athletic activity 321, and a team ranking 372 calculated from athletic teams' 341 scores of the team competitive activity 351. The database unit 4 further includes a ranking database 47 to save the individual ranking 371 and team ranking 372.

After the users 2 start the athletic activity 321, the competition result will be recorded in the competition scoring module 37. Or when the team competitive activity 351 is finished, the competition result will be also recorded in the competition scoring module 37. The competition scoring module 37 will rank the users 2 or the athletic teams 351 according to the scores, so that a plurality of users 2 can enjoy their exercise and improving their skill for better ranking.

For example, when a rank No. 150 user 2 beats a rank No. 50 user 2 in the athletic activity 321, the competition scoring module 37 will give the winner more scores than the other one, so that the winning user's 2 ranking will be risen up, but the other one's ranking will go down.

Preferably, the competition scoring module 37 will not be used by users, but used by approved groups or association to record the scores, so that the individual ranking 371 and the team ranking 372 can be accurate and more convincing. For example, a tennis association creates at least one athletic activity 321 on the present invention, and allows the users 2 to login to the interactive servo unit 3 and sign up. When the competition is finished, the result can be recorded by the competition scoring module 37 for calculating the individual ranking 371 or the team ranking 372, which can be browsed by the users 2. In practice, other scoring method can be used as well, and so should not be construed as limiting the invention.

The video broadcasting module 38 is provided with a plurality of videos 381 offered by at least one user 2. The database unit 4 further includes a video database 48 for saving the videos 381, and users 2 can watch the uploaded video 381 simultaneously on the interactive platform, and also can watch the video 381 saved in the video database 48.

Preferably, the interactive social networking platform provides the users 2 with a video delivery application set on the mobile communication devices. When the users 2 are watching an athletic activity 321, they can deliver the live performance to the interactive social networking platform via the mobile application, and other users 2 are allowed to watch, so that the present invention is provided with a live broadcasting function and the users 2 can also watch other past performance of the athletic activity 321 in the video database 48.

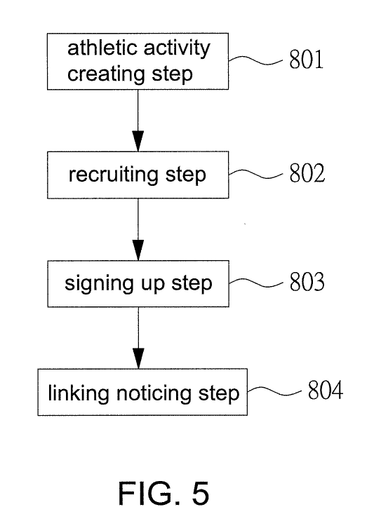

With reference to FIG. 5, a second embodiment of the present invention is provided, depicting a method for using the interactive social networking platform to linking people with similar interest in an athletic activity, and comprising an athletic activity creating step 801, a recruiting step 802, a signing up step 803, and a linking noticing step 804.

In the athletic activity creating step 801, the athletic activity linking module 32 offers at least one user 2 to create an athletic activity 321, and the related information of the athletic activity 321 will be saved into the activity database 42. The information includes an athletic activity type 3211, a required participant number 3212, a start time 3213 and an athletic activity venue 3214.

In the recruiting step 802, the information of the athletic activity 321 is published by the interactive social networking platform, and is classified according to the athletic activity type 3211 or the start time 3213, so that the users 2 signing in the interactive social networking platform can access to the athletic activity information.

In the signing up step 803, a plurality of users 2 can search for their desired athletic activity 321 based upon the information of the athletic activity 321. The athletic activity linking module 32 allows the users 2 to sign up the athletic activity 321, and the profiles of users 2 can be saved in the athletic activity 321.

In the linking noticing step 804, when the required participant number is fulfilled, the recruitment will be closed by the athletic activity linking module 32, and the communication module 33 will notify the participants, so that the users 2 can know whether the procedure of sign up is completed, and show up on the start time 3213 at the athletic venue 3214 to participate in the athletic activity 321.

With respect to the second embodiment of the present invention, it is noted that unacquainted users 2 with similar interest in an athletic activity are allowed to access to the interactive social networking platform, which is provided with lots of companion-required athletic activity 321 (such as badminton, tennis and basketball) and related information, so that the users 2 can choose their desired athletic activity 321 according to type, time and venue of activity. Therefore, people with similar interest in an athletic activity can be linked together by the interactive social networking platform.

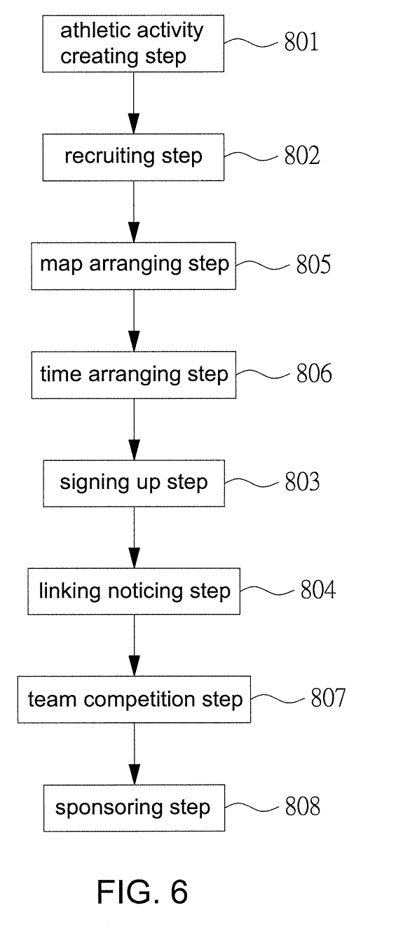

With reference to FIG. 6, a third embodiment of the present invention is provided, which is similar to the second embodiment, and so common features are not described again. A difference is that the method further comprises a map arranging step 805 occurred between the recruiting step 802 and signing up step 803, a time arranging step 806 occurred between the map arranging step 805 and the signing up step 803, a team competition step 807 occurred after the linking noticing step 804, and a sponsoring step 808 occurred after the team competition step 807.

In the map arranging step 805, the athletic activity 321 is further provided with a venue coordinates 3215. When the users 2 login to the interactive servo unit 3, the users 2 are required to type in their user coordinates 411 by the user module 31, which will be saved in the user database 41. When the activity database 42 saves a plurality of athletic activity 321 information and provides the users 2 for browsing, the athletic activity linking module 32 will plan routes for a plurality of users according to the distance between the venue coordinates 3215 and the user coordinates 411, so that the users 2 can find out the athletic activity 321 held on the nearest athletic venue 3214 and sign up.

In the time arranging step 806, because the activity database 42 has saved a plurality of start time 3213, the athletic activity linking module 32 can classify the athletic activity 321 based upon the sequence of start time 3213, so that the users 2 can search for the earliest athletic activity 321 and sign up.

In the team competition step 807, when the team organizing module 34 links users 2 with similar interest in an athletic activity to organize a plurality of athletic team 341, the team linking module 35 can offer at least one user 2 to create one team competitive activity 351 and offer the athletic teams 341 to participate, so that a plurality of athletic teams 341 can be linked together.

In the sponsoring step 808, when a plurality of athletic activities 321, athletic teams 341 or team competitive activities 351 are completed and published by the interactive social networking platform, the advertisement sponsoring module 36 can provide a plurality of outside suppliers 361 to sponsor at least a user 2, an athletic team 341, a team competitive activity 351 or combination thereof, so that people with similar interest in an athletic activity can be easily linked together. Besides, the advertisement sponsoring module 36 further offers the sponsoring outside suppliers 361 to play commercial advertisement, so that their publicity can be increased which is beneficial for the outside suppliers 361, the sponsored users 2, or the sponsored athletic teams 341. As for the users 2 who are eager to exercise can easily find out the adequate athletic activities 321.

With the aforementioned descriptions, the following benefits of embodiments of the present invention can be obtained:

1. Signing Up for the Athletic Activities

The activity linking module 32 is programmed to offer at least one user 2 to create at least one athletic activity 321 on the interactive servo unit 3, so that the users 2 can login to the interactive servo unit 3 to browse the related information and join in their desired athletic activity 321.

2. Signing Up for the Team Competitive Activity

The team organizing module 34 offers at least one user 2 to create at least one athletic team 341, and the team linking module 35 offers at least one user 2 to create a team competitive activity 351 and offers a plurality of athletic team 341 to sign up.

3. Linking People with Similar Interest in an Athletic Activity

The athletic activity 321 is published by the interactive servo unit 3, and the users 2 signing in the interactive social networking platform can browse the information related to the athletic activity 321, and choose to join in the athletic activity 321 based upon the athletic type 3211, so that people with similar interest in an athletic activity can be linked.

In conclusion, the present invention is provided with a characteristic of surfing for required information via internet, and establishes an interactive social networking platform for exercise, and allows unacquainted users 2 to login to the platform. The athletic activity linking module 32 provides the users 2 to respectively create different types of athletic activity 321, when the user access to the interactive servo unit 3, they can search for their desired athletic activity 321 and sign up. When the required participant number 3212 is fulfilled, the athletic activity linking module 32 will control the communication module 33 to notify the users 2, so that the users 2 with similar interest in an athletic activity can be linked together.

Besides, the team organizing module 34 offers at least one user 2 to create at least one athletic team 341, and allows users 2 with similar interest in an athletic activity can join in. The team linking module 35 offers a plurality of athletic team 341 to participate in the team competitive activity 351. The advertisement sponsoring module 36 provides a plurality of outside suppliers 361 to sponsor at least one user 2, one athletic team 341 or the team competitive activity 351, so that people with similar interest in an athletic activity can be linked together.

The foregoing detailed description is merely in relation to three preferred embodiments and shall not be construed as limiting the invention. It is to be understood that many other possible modifications and variations can be made without departing from the spirit and scope of the invention as hereinafter claimed.

What is claimed is:

1. A method for linking people with similar interest in an athletic activity comprising:
an interactive servo unit, including a user module, an athletic activity linking module, a communication module for contacting a plurality of users, a competition scoring module, and a video broadcasting module, the user module programmed to control the users' access right on the interactive servo unit, the athletic activity linking module programmed to offer at least one user to create at least one athletic activity on the interactive servo unit, the competition scoring module is provided with an individual ranking calculated from users' scores, and the video broadcasting module is provided with a plurality of videos offered by at least one user; and
a database unit, being electrically connected to the interactive servo unit, including a user database programmed for saving information from a plurality of users, an activity database programmed for saving the created athletic activities, a ranking database to save the individual rankings, a map database for planning route, and a video database for saving a plurality of videos, the user database saving the users' coordinate, the activity database saving the venue coordinates of the athletic activity, the athletic activity linking module using the user coordinate and the venue coordinates combined with the map database to plan a route for a plurality of users;
when the athletic activity starts, the users can watch the uploaded video simultaneously on the interactive platform, and also can watch the video saved in the video database;
when the user signing in the interactive social networking platform, and the activity database saving a plurality of athletic activities, the athletic activity linking module planning routes for a plurality of users according to the distance between the venue coordinate and the user coordinate;
a plurality of users accessing to the interactive servo unit and choose whether to join in the athletic activity, user's profile being saved in the athletic activity by the athletic activity linking module, the communication module controlled by the activity database notifying participants in the athletic activity, so that users with similar interest in an athletic activity linking together;
when the users participating in the athletic activities, competition result being recorded in the competition scoring module, which ranking the users according to scores, and updating individual ranking in the ranking database.

2. The interactive social networking platform as claimed in claim 1, wherein the interactive servo unit further includes a team organizing module and a team linking module, the team organizing module offering at least one user to create at least one athletic team, and allowing users with similar interest in an athletic activity to join in, when a plurality of athletic teams being created on the interactive social networking platform, the team linking module offering at least one user to create a team competitive activity and offering a plurality of athletic teams to sign up, the database unit further including the team database programmed to save the information of the athletic teams, and a competitive activity database programmed for saving the information of the team competitive activities.

3. The interactive social networking platform as claimed in claim 2, wherein the interactive servo unit further including an advertisement sponsoring module by which a plurality of outside suppliers can sponsor one of the athletic activity, the database unit further including a commercial sponsoring database programmed to save information of outside suppliers.

4. The interactive social networking platform as claimed in claim 3, wherein the interactive servo unit further includes a competition scoring module, which is provided with a team ranking calculated from teams' scores and is saved in the ranking database.

5. A method for linking people with similar interest in an athletic activity, being applied to the interactive social networking platform as claimed in claim 1, comprising the following steps:
an athletic activity creating step, wherein the athletic activity linking module offering at least one user to create an athletic activity, in which a required participant number being provided;
a recruiting step, wherein the athletic activity being published by the interactive social networking platform, so that users signing in the interactive social networking platform and accessing to the athletic activity related information;
a map arranging step, wherein when the user signing in the interactive social networking platform, and the activity database saving a plurality of athletic activities, the athletic activity linking module planning routes for a plurality of users according to the distance between the venue coordinate and the user coordinate;
a signing up step, wherein the users' registration being accepted by the athletic activity linking module, and the information of registered users being saved in the athletic activity; and
a linking noticing step, wherein when the participant number satisfying the requirement, recruitment being closed by the athletic activity linking module, and the communication module notifying the participants;
when the users participating in the athletic activities, the competition result being recorded in the competition scoring module, which ranking the users according to scores;
when the athletic activity starting, the users can watch the uploaded video simultaneously on the interactive platform, and also can watch the video saved in the video database.

6. The method as claimed in claim 5, wherein further comprising a team competition step, when people with similar interest in an athletic activity being linked to organize a team by the team organizing module, the team linking module offering at least one user to create one team competitive activity and offering the athletic teams to participate, so that a plurality of athletic teams can be linked together.

7. The method as claimed in claim 6, wherein further comprising a sponsoring step, the advertisement sponsoring module offering the outside suppliers to sponsor at least one user, one team, a team competitive activity or combination thereof.
